(19) United States
(12) Patent Application Publication
(10) Pub. No.: US 2008/0011592 A1
(43) Pub. Date: Jan. 17, 2008

(54) Main handle with a safety lock

(75) Inventors: Bernhard Liebert, Pfaffenhofen a. d. Glonn (DE); Thomas Blatz, Kaufering (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/823,807

(22) Filed: Jun. 27, 2007

(30) Foreign Application Priority Data
Jun. 29, 2006 (DE) 10 2006 000 316.0

(51) Int. Cl. H01H 9/28

(52) U.S. Cl. 200/43.11

(57) ABSTRACT

A main handle for an electrically operated power tool and in which a grip (8) of a motor switch (10) and an actuating element serving to unlock a safety lock (16) are arranged on the main handle (6) of the electrically operated power tool (2), with the actuating element having an actuating portion (24) which is accessible from outside a tool housing (4), with the safety lock (16) blocking actuation of the motor switch (10) in its normal position with a blocking area (34) which is swivelable in a movement path of the grip (8), and being movable, upon actuation of the actuating element, into a release position in which the actuation of the motor switch (10) is unblocked, and with the actuating element being formed by a rotatably supported turning element (18) at which the blocking area (34) is formed.

### BACKGROUND OF THE INVENTION

1. Field of the Invention

The invention is directed to a main handle of a power tool that is operated by an electric motor. A grip of a motor switch and actuating means serving to unlock a safety lock are provided on this main handle. The actuating means have an actuating portion which is accessible from outside tool housing. The safety lock blocks actuation of the motor switch in a normal position by means of a blocking area which is swivelable in a movement path of the grip. By actuating the actuating means, the safety lock can be moved into a release position in which the actuation of the motor switch is unblocked.

2. Description of the Prior Art

In main handles of the type mentioned above, it is possible to actuate the motor switch with a hand holding the main handle by actuating the grip which accordingly sets the power tool in operation. In addition, the safety lock is provided in order to prevent the power tool from being switched on unintentionally. In its initial position, this safety lock prevents an actuation of the motor switch and can also be moved by the hand holding the main handle into a release position in which the motor switch can be actuated.

DE 33 13 704 A1 discloses a handheld power tool having a grip on which a pawl is arranged for actuating a motor switch. Further, an anti-switch-on device is provided at the grip. This anti-switch-on device has an angle lever which is rotatably supported and biased in an initial position by a pressure spring and by means of which the pawl can be blocked. A press button is provided at the grip for swiveling the angle lever against the pressure spring and is held in a housing wall so as to be displaceable and contacts an arm of the angle lever.

The known grip is disadvantageous in that the anti-switch-on device has a relatively large number of individual parts and is therefore relatively complicated to assemble and relatively susceptible to malfunction. Further, the press button which projects relatively far out of the tool housing often jams, for example, when the power tool is put away into a tool box, so that the anti-switch-on device can easily be damaged.

### SUMMARY OF THE INVENTION

It is the object of the present invention to overcome the above-mentioned disadvantages in a main handle with a grip of a motor switch and a safety lock and to ensure a simple construction which is less susceptible to damage.

According to the invention, this and other objects of the present invention, which will become apparent hereinafter, are achieved in that the actuating means are formed by a rotatably supported turning element, with the blocking area being formed integral with this turning element at the same time. Owing to this construction of the actuating portion and of the blocking area at an individual, common element, the number of elements required for the safety lock is reduced to a minimum, which simplifies production and assembly. Further, a very stable safety lock which is less susceptible to damage or malfunction can be provided in this way.

In a particularly preferred embodiment form, the actuating portion has a shorter distance from an axis of rotation of the turning element than the blocking area. In this way, a relatively large swiveling movement of the blocking area can be achieved by a slight swiveling of the actuating portion so that switching the safety lock between the normal position and the release position is more comfortable and more precise.

The actuating portion is advantageously formed by a portion of the turning element which projects from the tool housing in the normal position and which projects at least mostly through a housing opening into a housing interior in the release position. Accordingly, the actuating portion lies relatively close to a surface of the tool housing in the release position, so that the actuating means can be held in the actuated position by a user in a particularly comfortable manner during operation. In this connection, actuation can be carried out not only by finger pressure, particularly by means of the thumb, but also by other parts of the hand such as, for example, by the ball of the hand. Accordingly, the safety lock can be actuated easily in different positions of a hand that holds the main handle.

The turning element preferably projects out of the tool housing at a recess in the tool housing so that jamming by the portion of the turning element projecting from the tool housing can be prevented in the normal position as well as in the release position.

The turning element is advantageously biased in the normal position by a spiral spring or leg spring. Accordingly, releasing the grip again first causes an automatic blocking of the motor switch by the safety lock.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partial cross-sectional view of a main handle with a safety lock in the normal position;

FIG. 2 a partial cross-sectional view of the main handle according to FIG. 1 with the safety lock in the release position; and

FIG. 3 a partial cross-sectional view of the main handle according to FIG. 2 in which the grip of a motor switch is pressed.

### DETAILED DESCRIPTION OF THE PREFERRED EMBODIMENT

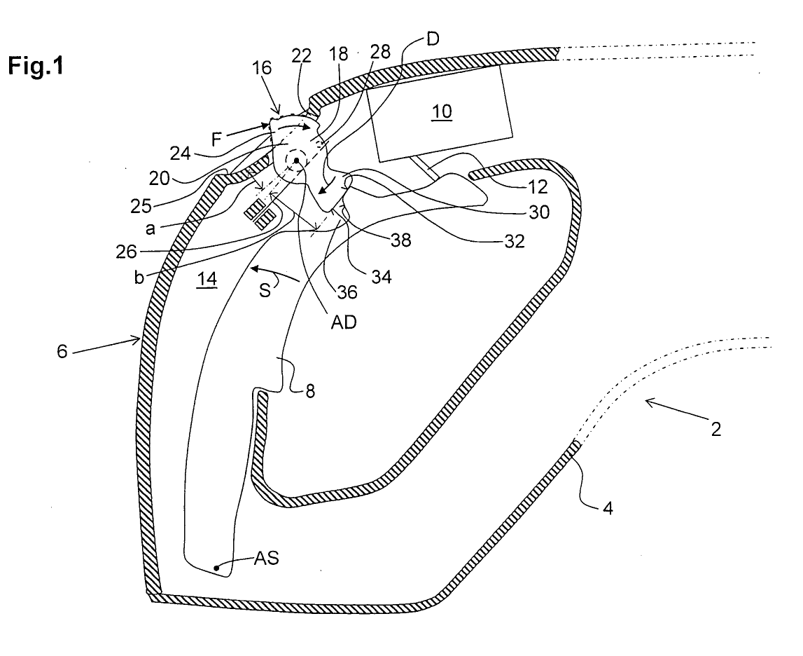

FIG. 1 shows an end of an electrically operated hand-held power tool 2 in the form of a severing tool or grinding tool, which end is remote of a tool holder, not shown. This hand-held power tool 2 has a tool housing 4 which forms an arc-shaped main handle 6 at this end. A grip 8 for actuating a motor switch 10 by a hand holding the main handle 6 by means of a switching member 12 is provided on this main handle 6. The motor switch 10 is arranged in a housing interior 14 which is defined by the tool housing 4. The grip 8 is formed by a switch pawl that is held so as to be swivelable along a swiveling direction S around a swiveling axis AS. Actuation of the motor switch 10 is possible in various positions of the hand holding the main handle 6 by means of this grip 8. In FIG. 1, the grip 8 is in a passive position in which the motor switch 10 is not actuated.

Further, a safety lock, designated in its entirety by 16, is provided at the main handle 6. This safety lock 16 substantially comprises a two-legged turning element 18 which is held at the tool housing 4 so as to be swivelable around an axis of rotation AD. The turning element 18 has actuating means in the form of an actuating leg 20 which projects out of the tool housing 4 through a housing opening 22 in the normal position shown in FIG. 1 by an outer actuating portion 24 shown in dash-dot lines. The actuating portion 24 and the housing opening 22 are arranged in a trough-shaped depression 25 of the tool housing 4 so that the actuating leg 20 is protected against jamming. At the same time, however, the actuating portion can easily be actuated by a finger, particularly the thumb, or the ball of a hand holding it. In addition, the turning element 18 is biased in the normal position by a leg spring 26 which acts on the tool housing 4 on one side and at a corresponding stop 28 of the turning element 18 on the other side.

In this normal position, a blocking leg 30 of the turning element 18 is arranged in a movement path of a contact area 32 of the grip 8 with respect to the swiveling direction S. In the normal position, this contact area 32 of the grip 8 contacts a blocking area 34 of the blocking leg 30 that is formed by a surface so that a swiveling movement of the grip 8 into the housing interior 14 is blocked according to FIG. 1. Accordingly, the grip 8 is held in the passive position and prevents the motor switch 10 from being actuated.

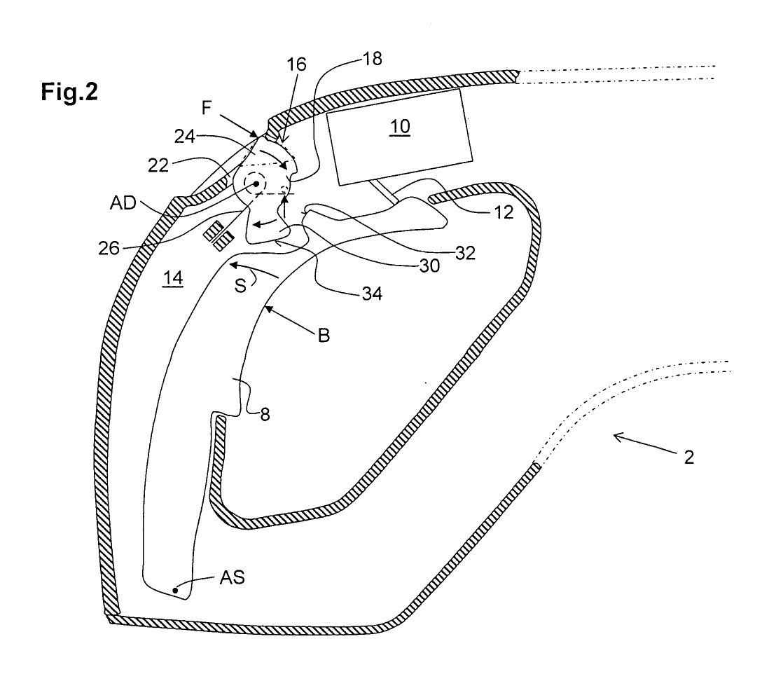

By applying a pressing force F to the actuating portion 24, the turning element 18 can be rotated into a release position against the force of the leg spring 26 around the axis of rotation AD along a rotating direction D as is shown in FIG. 2. A relatively large swiveling movement of the blocking area 34 is generated by a relatively slight swiveling movement of the actuating portion 24 because the actuating portion 24 is at a distance a from the axis of rotation AD that is less than the distance b between the blocking area 34 and the axis of rotation AD.

In the release position according to FIG. 2, the blocking leg 30 is arranged so as to be offset in swiveling direction S relative to the movement path of the contact area 32 so that the grip 8 is no longer blocked by the blocking area 34. By applying an actuating pressure B to the grip 8, this grip 8 can accordingly be swiveled around the swiveling axis AS in the swiveling direction S into the housing interior 14 into an active position.

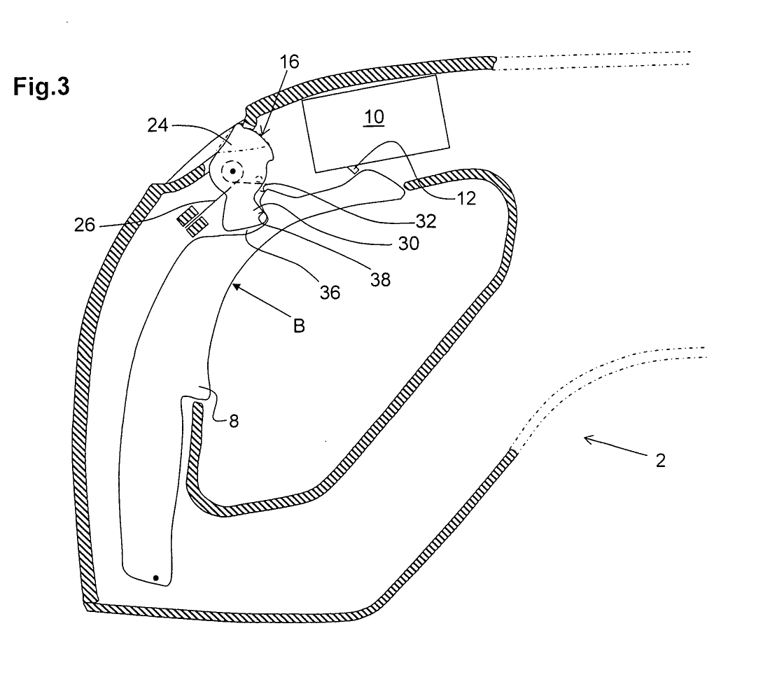

In this active position according to FIG. 3, the grip 8 presses against the switching member 12 which in turn actuates the motor switch 10. In this way, the hand-held power tool 2 is put into operation. The blocking area 34 is arranged in a recess 36 of the grip 8 which is formed adjacent to the contact area 32 and is limited on one side by a rotary stop 38 which is contacted by the blocking leg 30 due to the force of the leg spring 26. The safety lock 16 is held in the release position by this contact even without applying a pressing force F to the actuating portion 24 as long as the motor switch 10 is actuated by applying the actuating pressure B to the grip 8.

As soon as the actuating pressure B is removed from the grip 8 to stop the hand-held power tool, the grip 8 swivels out of its active position back into the passive position. Since the rotary stop 38 is at a distance from the blocking leg 30, the turning element 18 can simultaneously be swiveled back by the leg spring 26 into the normal position shown in FIG. 1 in which an unintended switching on of the motor switch 10 by unintentionally pressing on the grip 8 is blocked.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A main handle (6) for an electrically operated power tool (2) having an electric motor, the main handle (6) comprising a motor switch (10) provided thereon and having a grip (8); a safety lock (16) provided on the main handle (6) for blocking the motor switch (10) from being unintentionally actuated and having a normal position in which a blocking area (34) of the safety lock (16) is displaced in a movement path of the grip (8), and a release position in which the motor switch (10) can be actuated; and actuating means for displacing the safety lock (16) into the release position thereof and including a rotatably supported turning element (18) having an actuating portion (24) accessible from outside of a tool housing (4) the blocking area (34) being formed integrally with the turning element (18).

2. A main handle according to claim 1, wherein the actuating portion (24) is spaced by a shorter distance (a) from an axis of rotation (AD) of the turning element (18) than the blocking area (34).

3. A main handle according to claim 1, wherein the actuating portion (24) is formed by a portion of the turning element (18) which projects from the tool housing (4) in the normal position of the safety lock (16) and which projects at least mostly through a housing opening (22) into a housing interior (14) in the release position of the safety lock (16).

4. A main handle according to claim 1, wherein the turning element (18) projects out of the tool housing (4) at a recess (25) in the tool housing (4).

5. A main handle according to one of claim 1, comprising a leg spring (26) for biasing the turning element (18) into the normal position of the safety lock (16).
